(19) United States
(12) Patent Application Publication
(10) Pub. No.: US 2009/0164275 A1
(43) Pub. Date: Jun. 25, 2009

(54) REVENUE-SHARING TO INCENTIVIZE USERS TO REVEAL ONLINE PURCHASING INTERESTS

(76) Inventors: Yiling Chen, Jersey City, NJ (US); Arpita Ghosh, Santa Clara, CA (US)

Correspondence Address: MPG, LLP AND YAHOO! INC., 710 LAKEWAY DRIVE, SUITE 200, SUNNYVALE, CA, 94085, US

(21) Appl. No.: 11/963,595

(22) Filed: Dec. 21, 2007

(51) Int. Cl. G06Q 30/00; G06Q 10/00

(52) U.S. Cl. 705/7; 705/14

(57) ABSTRACT

The various embodiments of the present invention provide systems and methods to incentivize online users to reveal their online purchasing interests so that advertisements matches their online purchasing interests can be displayed to the users. When users follow the displayed advertisements that match their online purchasing interests to make purchases, users are rewarded by sharing a portion of the advertising (or advertisement) revenue that are related to their online purchases and are collected by the web site(s) that displays the advertisements. The payout for the advertisements by the advertisers to the web site(s) is based on click-per-action (CPA) model, which generally pays more substantially per purchase action. Therefore, the users, who share a portion of the advertisement revenue directly related to their online purchases, can receive more substantial rewards. The reward is mainly monetary (or financial gain) and can come in various forms, such as discount, or credit.

### BACKGROUND OF THE INVENTION

1. Field of the Invention

This invention relates generally to online advertisement and more specifically relates to incentivize online users to reveal their online purchasing interests to provide users advertisements related to users' revealed purchasing interests.

2. Description of the Related Art

On-line advertising may be used to accomplish various business goals, ranging from building brand awareness among potential customers to facilitating on-line purchases of products and/or services. A number of different kinds of page-based or video-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. Some Internet technologies enable rich video advertisements.

Most on-line advertisements are not effective in reaching on-line users because the advertisers have no knowledge or only very limited knowledge regarding the receiving users. Advertisers often can only target advertisements based on a vague understanding of the demographics of users viewing certain media spaces or web pages. Therefore, most of on-line advertisement is either not targeted at all, or not targeted effectively. Since on-line advertisements are presented to the users with little or no knowledge of who the users are or what the users want, the chance that on-line users will be interested the advertisements displayed to them is small. Therefore, many on-line users simply choose to ignore a majority of on-line advertisements.

It is in this context that embodiments of the present invention arise.

### SUMMARY OF THE INVENTION

The various embodiments of the present invention provide systems and methods to incentivize online users to reveal their online purchasing interests so that advertisements matches their online purchasing interests can be displayed to the users. When users follow the displayed advertisements that match their online purchasing interests to make purchases, users are rewarded by sharing a portion of the advertising (or advertisement) revenue that are related to their online purchases and are collected by the web site(s) that displays the advertisements. The payout for the advertisements by the advertisers to the web site(s) is based on click-per-action (CPA) model, which generally pays more substantially per purchase action. Therefore, the users, who share a portion of the advertisement revenue directly related to their online purchases, can receive more substantial rewards. The reward is mainly monetary (or financial gain) and can come in various forms, such as discount, or credit.

Users are motivated to reveal their online purchase (or purchasing) interests because users are rewarded. FN addition, users receive advertisements that directly relate to their online purchasing interests, which improves user satisfaction. The advertisers pay the web site(s) to display the advertisements based on CPA model, which is very effective for the advertisers since the advertisers only pay when purchases (or transactions) occur. Although the web site(s) that displays matched ads need to share a portion of the advertising revenue with the users, the web site(s) can have more satisfied users and advertisers and can gain additional users and advertisers. In the long run, the web site(s) can gain more advertising revenue.

It should be appreciated that the present invention can be implemented in numerous ways, including as a method, a system, or a device. Several inventive embodiments of the present invention are described below.

In one embodiment, a method for incentivizing a user to reveal the user's online purchasing interests is provided. The method includes receiving the user's online purchasing interests in a web site coupled to the Internet. The method also includes matching the user's online purchasing interests with advertisements paid by a click-per-action (CPA) model. The method farther includes displaying advertisements matched with the user's online purchasing interests to the user by the web site. In addition, the method includes detecting the user following one of the matched advertisements to make an online purchase. The user is provided with a reward by the web site. The reward is a portion of an advertisement revenue earned by the web site as a result of the user's online purchase based on the CPA model.

In another embodiment, a system for managing user interaction with advertisements is provided. The system includes a web site for displaying advertisements and content. The system also includes an online-purchasing-interests server for storing a user's online purchasing interests. The system further includes an advertisement server for storing advertisements paid by a click-per-action (CPA) model. The advertisement server is configured to match the user's online purchasing interests with the stored advertisements, the advertisement server configured to display matched advertisements on the website for a user. The advertisement server includes logic for detecting when the user follows one of the displayed matched advertisements and makes an online purchase and provides a reward to the user. The reward is a portion of an advertisement revenue earned by the web site that is directly related to the online purchase.

In yet another embodiment, computer readable media including program instructions for incentivizing a user to reveal the user's online purchasing interests are provided. The computer readable media include program instructions for receiving the user's online purchasing interests in a web site coupled to the Internet. The computer readable media also include program instructions for matching the user's online purchasing interests with advertisements paid by a click-per-action (CPA) model. The computer readable media further include program instructions for displaying advertisements matched with the user's online purchasing interests to the user by the web site. In addition, the computer readable media include program instructions for detecting the user following one of the matched advertisements to make an online purchase. The user is provided with receives a reward. The reward is the portion of the advertisement revenue earned by the web site as a result of the user's online purchase based on the CPA model.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows a diagram illustrating an Internet portal system operating over the Internet, in accordance with one embodiment of the present invention.

FIG. 2A shows a window of USER-1 that includes an online purchase interests box, in accordance with one embodiment of the present invention.

FIG. 2B shows an online purchasing interests revealing window, which allows USER-1 to enter his/her online purchasing interests to Internet portal system, in accordance with one embodiment of the present invention.

FIG. 2C shows a window with a list of items that USER-1 is interested in purchasing, in accordance with one embodiment of the present invention.

FIG. 2D shows a window with different types of cameras for USER-1 to select, in accordance with one embodiment of the present invention.

FIG. 2E shows a window for a model-1 of Nikon cameras, in accordance with one embodiment of the present invention.

FIG. 2F shows a system and a method for entering purchasing interests by a user, in accordance with one embodiment of the present invention.

FIG. 2G shows a summary of purchasing interests of USER-1, in accordance with one embodiment of the present invention.

FIG. 3A shows a window of USER-1 with a button for entering online purchasing interests, in accordance with one embodiment of the present invention.

FIG. 3B shows a window for USER-1 to enter online purchasing interests, in accordance with one embodiment of the present invention.

FIG. 4A shows a system for incentivizing users in revealing online purchasing interests, in accordance with one embodiment of the present invention.

FIG. 4B shows a process flow for incentivizing users in revealing online purchasing interests, in accordance with one embodiment of the present invention.

FIG. 5 shows a summary of online purchases with rewards of USER-1, in accordance with one embodiment of the present invention.

### DETAILED DESCRIPTION

The various embodiments of the present invention provide systems and methods to incentivize online users to reveal their online purchasing interests so that advertisements matches their online purchasing interests can be displayed to the users. When users follow the displayed advertisements that match their online purchasing interests to make purchases, users are rewarded by sharing a portion of the advertising (or advertisement) revenue that are related to their online purchases and are collected by the web site(s) that displays the advertisements. The payout for the advertisements by the advertisers to the web site(s) is based on click-per-action (CPA) model, which generally pays more substantially per purchase action. Therefore, the users, who share a portion of the advertisement revenue directly related to their online purchases, can receive more substantial rewards. The reward is mainly monetary (or financial gain) and can come in various forms, such as discount, or credit.

Users are motivated to reveal their online purchase (or purchasing) interests because users are rewarded. In addition, users receive advertisements that directly relate to their online purchasing interests, which improves user satisfaction. The advertisers pay the web site(s) to display the advertisements based on CPA model, which is very effective for the advertisers since the advertisers only pay when purchases (or transactions) occur. Although the web site(s) that displays matched ads need to share a portion of the advertising revenue with the users, the web site(s) can have more satisfied users and advertisers and can gain additional users and advertisers. In the long run, the web site(s) can gain more advertising revenue.

Online advertising is a form of advertising that uses the Internet and World Wide Web in order to deliver marketing messages and attract customers. Examples of online advertising include contextual ads on search engine results pages, banner ads, and e-mail marketing, etc. A web banner or banner ad is a form of advertising on the World Wide Web. This form of online advertising entails embedding an advertisement into a web page. It is intended to attract traffic to a website by linking them to the web site of the advertiser. No matter what formats the advertisements are delivered, the goals of the advertisers for putting out the advertisement are to gain customers and to increase sales.

As described above, most on-line advertisements are not effective in reaching on-line users because the advertisers have no knowledge or only very limited knowledge regarding the receiving users. Advertisers often can only target advertisements based on a vague understanding of the demographics of users based on users' online activities, such as viewing certain media spaces or web pages, conducting searches, or joining certain online groups. Therefore, most of on-line advertisement is either not targeted at all, or not targeted effectively. Since on-line advertisements are presented to the users with little or no knowledge of what the users want, the chance that con-line users will be interested in advertisements displayed to them is fairly small. Many on-line users simply choose to ignore a majority of on-line advertisements. Due to this, the chance for online users to follow the displayed advertisements to make online purchases is even smaller.

Recently, there are new advertising strategies aimed at identifying users' profiles and interests by plowing through user's online activities, such as e-mails, chats, instant messages, etc. Although these new strategies can likely identify users' backgrounds and interests better and can improve targeting the advertisements to the users, the activities of going through user's personal information, such as emails, chats, instant messages, are intrusive to the users. Users might be turned off by the fact that their personal information is accessed to gain knowledge of them. The web sites, portals, or social-networking sites that conduct such activities to gain knowledge of users stand to lose the trust of the users.

An alternative way is to let the users tell the advertisement hosting sites their interests in products and services (or shopping interests). If users reveal the information willingly, users' personal data are not studied or examined to determine their backgrounds or interests. To encourage users to reveal their shopping interests, users need incentives, such as discount, credit or gifts.

Currently, advertisement-hosting sites receive payments from advertisers for displaying the advertisements. The payments of these advertisements are mainly in three formats (or models): (1) cost per impression (CPM), (2) cost per click (CPC), and (3) cost per action (CPA). CPM (Cost Per Impression) is where advertisers pay for exposure of their message to a specific audience. CPM costs are priced per thousand impressions. The M in the acronym is the Roman numeral for one thousand. CPC (Cost Per Click) is also known as Pay per click (PPC). Advertisers pay every time a user clicks on their listing and is redirected to their website. They do not actually pay for the listing, but only when the listing is clicked on. This system allows advertising specialists to refine searches and gain information about their market. CPA (Cost Per Action) or (Cost Per Acquisition) advertising is performance based. In this payment scheme, the publisher takes all the risk of running the ad, and the advertiser pays only for the amount of users who complete a transaction, such as a purchase or sign-up. This is the best type of rate to pay for advertisers and the worst type of rate to charge for web sites that display the advertisement.

Based on the CPA model, since the advertisers only pay where the users really completes a transaction, the advertisers usually are more willing to pay a higher price per action (or transaction). For example, for a camera that costs $400, the company that sells the camera might be willing to pay the web site that display the ad 10% or even 20% of the regular price based on the CPA model.

Users use web sites for many reasons, such as to read news, to exchange emails with friends, to chat with friends, to conduct search, to exchange photos, and to share videos etc. While the users get online doing such activities, telling advertisers or web sites what they want to purchase (or shop) on line in the near future is likely not on their minds. The users need incentives, such as money, or price reduction (discount), in order to make efforts, such as entering words or clicking selections buttons, to reveal their online purchasing interests.

As mentioned above, based on the CPA model, advertisers (or merchants) are more willing to pay a more substantial amount of money for each transaction (purchase) performed by users after viewing the advertisement. If users reveal to a web site(s) their online purchasing (shopping) interests, the web site matches their online purchasing interests with advertisements that pay by the CPA model (more significant pay). The web site then display the matched advertisements to the users. When users follow the matched advertisements to make transactions (or purchases), the users' revealing of their online purchasing interests directly contributes to the transactions. The web site would share a portion of the advertising revenue gained from the advertisers with the users as rewards for revealing their purchasing interests. The rewards can come in many forms, such as discount in the merchandise or service users purchase or monetary credit with the web site, which can be redeemed at a later time. Other types of rewards, such as gifts, are also possible.

The financial incentive would encourage users to reveal their online purchasing (or shopping) interests. For some users, the financial incentives need to be substantial to be worthwhile for them to reveal their purchasing interests. As discussed above, advertisers (or merchants) are willing to pay a more substantial fee for an advertisement based on CPA model. For example, if a user buys a $400 camera, the advertiser might be willing to pay the web site that display advertisement to online users 15% (or $60) of the cost of regular price of the camera based on CPA model. The web site can share a portion of this advertising revenue, such as ⅔ of it ($40), with the user and keeps the rest ($20). As mentioned above, the sharing can come in the form of discount or credit with the web site. An user purchasing relative expensive items, such as $400, would welcome such a substantial discount or credit, such as $40. The user plans to buy the camera anyway, even without the discount. By making an effort of revealing to the web site the user's purchase interests, the user get a substantial discount, such as $40 off a $400 purchase. The financial gain by the users, such as $40 in this example, should be sufficient to incentivise many users to reveal their purchasing interests. The matched advertisements are automatically brought to the users' attention after they make the revealing. Users do not need to flip through newspaper ads or conduct online searches to look for discount. Users save efforts in looking for deals.

In addition, when users use the web site(s), advertisements that match their purchasing interests are revealed to them, instead of advertisements for products or services not interested by the users. Users' satisfaction with the web site(s) can be increased.

Although the web site receives a smaller portion of the advertisement revenue, such as ⅓ (or $20) in the case discussed above, the web site can potentially gain more revenue in the long term if more users are incentivized by the rewards to reveal online purchase interests and to make transactions through matched advertisements. For example, using the example described above, the camera advertiser (or merchant) is willing to pay $60 based on CPA model. The web site can keep all $60 without sharing the ad revenue. In this case, users interested in the cameras that are advertised could buy the camera online, if the user happens to see the advertisement. Alternatively, they buy the cameras through regular channels by going to store or by going to the website of the merchant, who sponsors the camera advertisement. When the user purchases the camera by going to the store or to the website of the merchant, the web site does not get any ad revenue based on CPA model.

Assuming in a two-week time frame there are 500 online users interested in buying the cameras. 10% of them (people who are interested in buying such camera) happens to see the online ad displayed by the web site, which is not matched or targeted with the users' revealed online purchase interests. 50% of the users who see the online ad really makes the online transaction and buys the camera by clicking on online advertisement provided by the web site. In this case, the web site receives $60 per transaction and the web site would receive $1500 (or $60×10%×50%×500) from the advertiser during this two weeks. However, if users are incentivized to reveal their shopping interests, a higher percentage of the interested buyers, such as 25%, can be identified becaused they are incentivised to tell the web site that they are interested in buying the camera. Of these 25% interested buyers, 80% of them would follow the matched online ad to finish the purchase transaction, because they wants to buy the camera and they know they would receive rewards, such as discount or credit (for example $40). In this case, the web site would receive $20 per transaction and the web site would receive $2000 ($20×25%×80%×500) from the advertiser (or merchant). Although the web site receive less money for each transaction, the web site overall receive higher revenue due to higher rate of conversion and better targeting of advertisement.

Web site(s) that wants to incentivize users to reveal their online purchase interests need to provide sufficient incentives for users to make the effort in revealing the information. CPA payment model for advertisements provide higher payout for each advertisement that has resulted in a transaction, which makes it possible for web site(s) that receives such the higher payout (higher revenue) per transaction to share a portion of the higher payout to the user that makes the transaction. The web site(s) that is suitable for implementing the method and system for rewarding and incentivizing users for revealing their online purchasing interests described above should have contracts or systems in place for advertisers (or merchants) to pay based on CPA model. In addition, the web sites that are suitable for implementing such method and system are web sites that has a large number of users and users visiting the sites regularly. Examples of web sites that has a large number of users and users visiting the sites regularly include, but not limited to, Internet portals, such as Yahoo!, search sites, news sites (information-providing sites), networking sites, instant messaging sites, etc.

As mentioned above, users benefit from the rewards for revealing purchasing interests method. Users get discounts or credits that might not be there if users go through other channels to purchase the camera. Users also save the effort of shopping around, such as checking newspaper ads for discounts. Instead, users receive desired advertisement(s) with discounts. All users need to do is filling out some forms or questionares on the web site(s). Examples of how the methods and systems for rewarding users who make online purchases after revealing their online purchase interests are described below.

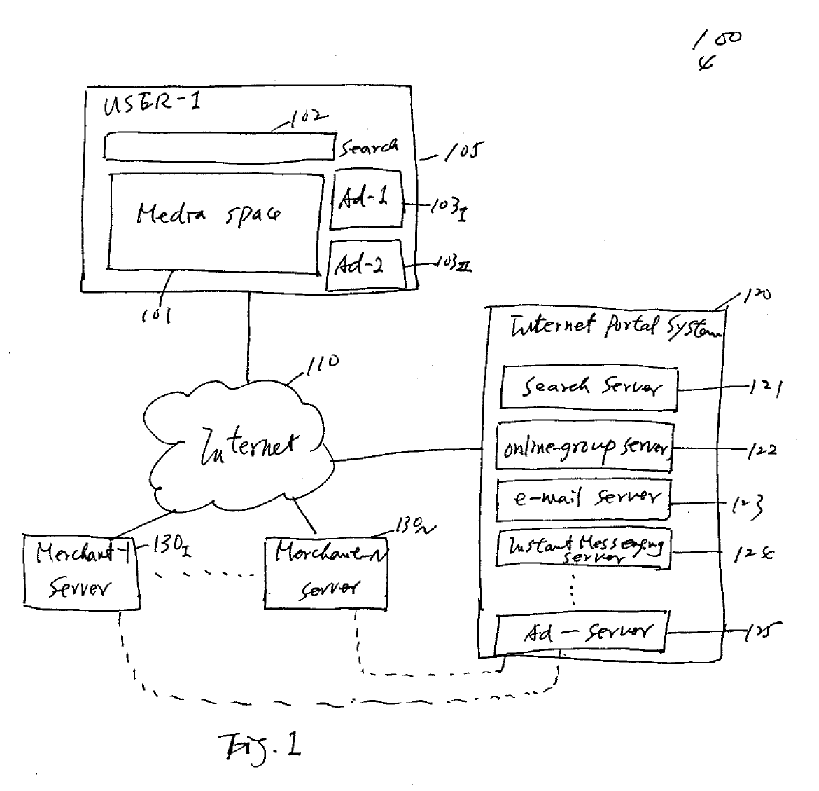

FIG. 1A shows a diagram illustrating an Internet portal system 100 operating over the Internet 110, in accordance with one embodiment of the present invention. An online USER-1 creates an online user window 105 on a client computer of USER-1. The window 105 of USER-1 is a graphical user interface. An Internet portal system 120 is also connected to the Internet 110 to interact with the window 105 of USER-1. The Internet portal system 120 provides services, such as search, online groups, emails, and instant messaging, etc., to users, such as USER-1.

USER-1 accesses information available on the Internet portal systems or on the Internet 110 through Internet portal system 120. An example of the Internet portal system 120 is a system for Yahoo! Internet portal, which provides tools to allow users to conduct online searches, to form online groups, to share photos, to exchange emails, and to exchange Instant Messages, etc. through Yahoo! Internet portal.

In the Internet portal systems 120, there are a number of sub-systems (or servers) that provides users, such as USER-1, various online services, as shown in FIG. 1. For example, the sub-systems (or servers) can include, but not limited to, service-providing servers, such as a search server 121 for receiving search requests and providing search results to users, an online-group server 122 for users to form online groups and to exchange information with members in the online groups, an email server 123 for users to send and receive emails, an instant messaging server 124 for users to send and receive instant messages, etc.

There are other types of servers in the Internet portal system 120, or are coupled to the Internet portal system. For example, the Internet portal system 120 can also include an advertisement (or ad) server 125 that provides advertisements for users to view while the users interact with the Internet portal system. These servers interact with one another to provide services to the users of the Internet portal system 120. For example, the advertisement server (or ad server) 125 is coupled to other servers, such as search server 121, online group server 122, email server 123, and instant messaging server 124. When users conduct search, interact with contents or members of online groups, exchange emails and instant messages with one another, advertisements always appear in the users' media spaces (or web pages) of the Internet portal. For example, in USER-1's window 105, USER-1 is interacting with the Internet portal system 120 to read his/her daily news that would appear in space 101 of window 102. Internet portal system 120 provides the daily news to the space 101 of window 102 through its news server (not shown). In window 102 of USER-1, there is also a search box 102, which allows USER-1 to enter search key words to conduct searches. Next to the space 101, there are a couple of advertisements, 103_{II} and 103_{II}, displayed in window 102 for USER-1 to view.

USER-1 can view the content of the Ad-1 103_{I}. Merchant-1 server 130, provides content of Ad-1 103_{I}. Servers, such as Merchant-1 server 130, to Merchant-N server 130_{N}, provide advertisements (or ads) to ad server 125 of Internet portal system 120. When USER-1 views the content of Ad-1 103_{I}, USER-1 might like the product or service displayed in Ad-1 103_{I} and follow a link on Ad-1 103I to make purchase (or transaction) with Merchant-1 server 103_{I}. In another embodiment, Merchant-1 has separate servers handing advertisement and transaction. The advertisement provided by ad server 125 of Internet portal system 120 can be linked to a number of online-merchant servers, such as Merchant-1 server 130_{I} to Merchant-N server 130_{N}. Alternatively, the merchant servers, such as Merchant-1 server 130_{I} and Merchant-N server 130_{N} can provide advertisements to the ad server 125 through Internet 110.

As mentioned above, without users' revealing, Internet portal system 120 has limited knowledge (or information) about USER-1's purchasing interests. Internet portal system 120 can display advertisements to USER-1 based on USER-1's profile, such as age, sex, geographical location, or search key words, gathered by the Internet portal system 120. However, this collected user profile information is not tied directly to USER-1's purchasing interests. The Ad server 125 can only guess what USER-1 might be interested in purchasing and displayed related advertisements to USER-1. The chance for USER-1 to view the displayed advertisements, such as Ad-1 103_{I} and Ad-2 103_{II} is fairly small. The chance for USER-1 to make purchase (or transaction) of the products or services displayed in Ad-1 103_{I} and Ad-2 103_{II} is even smaller.

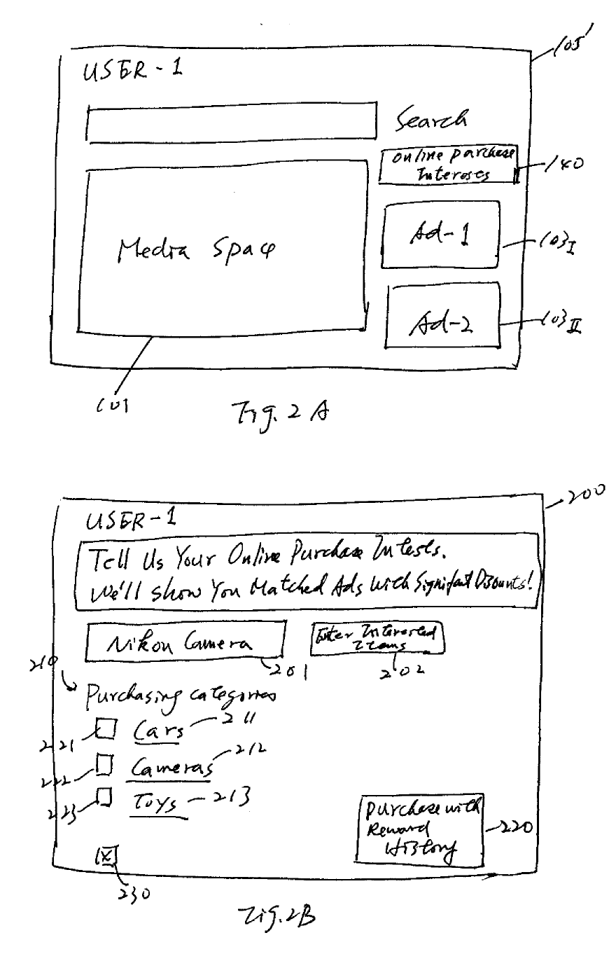

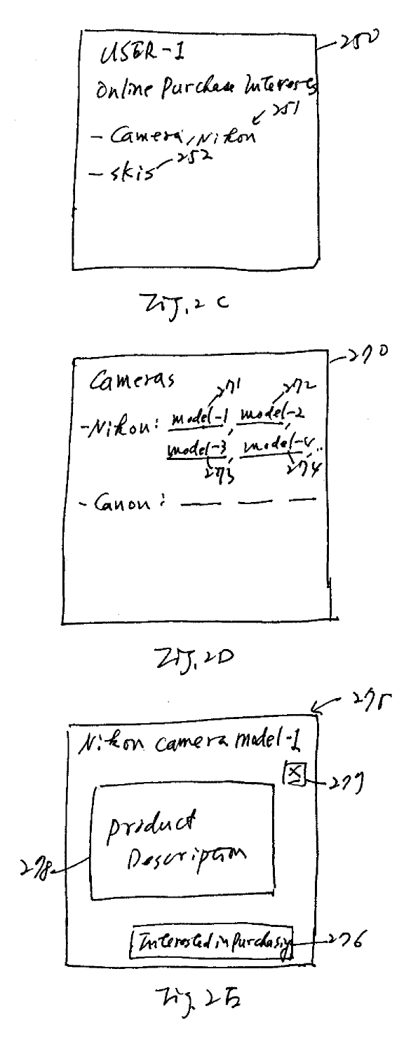

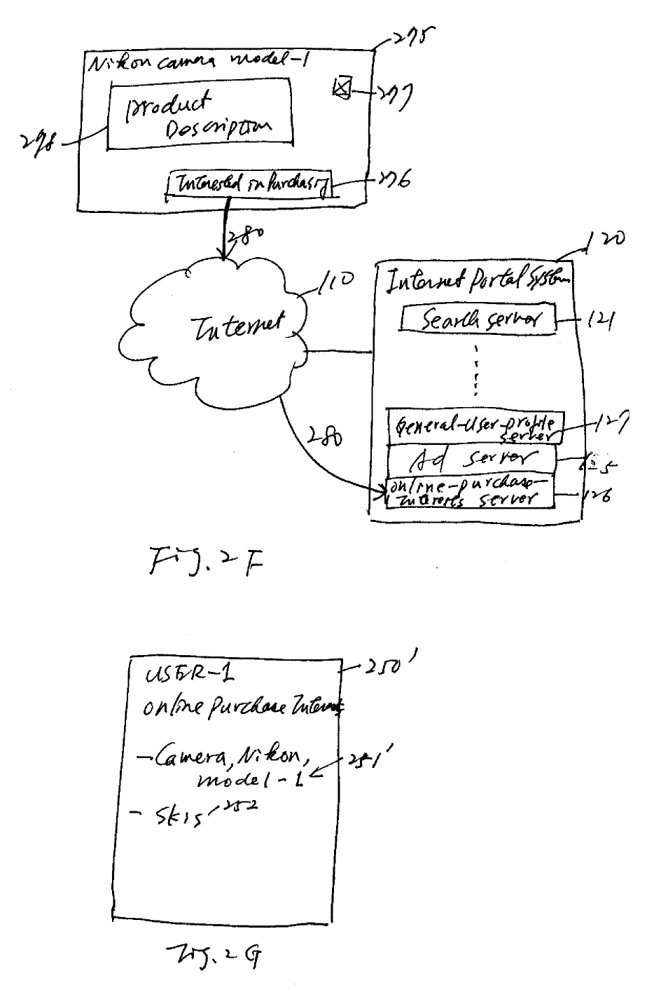

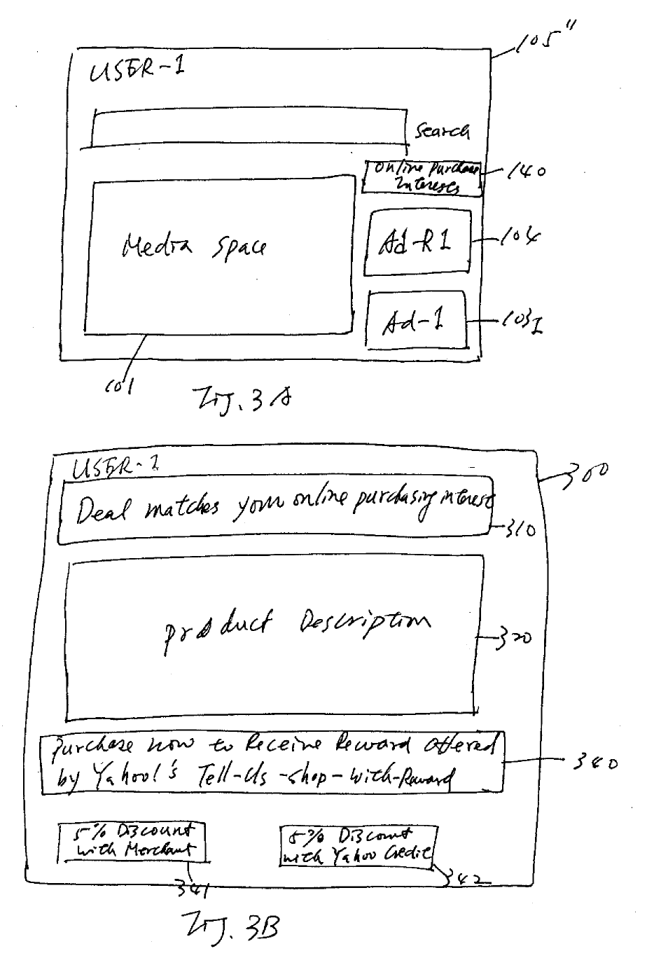

FIG. 2A shows an embodiment of window 105′ of USER-1 that include an online purchase interests box 140. Based on advertisement or promotional of the online purchase interests box 140 done by the Internet portal, USER-1 knows that he/she can get discounts or rewards if he/she reveals online purchasing interests through the online purchase interests box 140 and makes transactions (or purchases) following matched advertisements displayed to USER-1. When USER-1 clicks on box 140, an online purchasing interests revealing window 200 (as shown in FIG. 2B), which allows USER-1 to enter his/her online purchasing interests to Internet portal system 120, appears, in accordance with one embodiment of the present invention.

In one embodiment, in window 200, there are words near the top of window that describe the benefit of revealing online purchase interests, such as “Tell Us Your Online Purchasing Interests. We'll Show You Matched Ads With Significant Discounts!,” to briefly describe to users, such as USER-1, how the system work. In another embodiment, these words are not displayed in window 120. Instead, users, such as USER-1, are educated on how the system works by other promotion or campaign provided by Internet portal system 120.

In window 200, there is a box 201 that allows USER-1 to type in words describing his/her purchase (or purchasing) interests. For example, USER-1 is interested in purchasing a Nikon camera. However, USER-1 does not know what model he/she wants yet. USER-1 can enter “Nikon camera” in box 201. When USER-1 pushes the button 202 of “enter interested items”, the words “Nikon camera” are sent to an online-purchase-interests server 126 (as shown in FIG. 2F) linked to the Ad server 125 in the Internet portal system 120. A window 250 with a summary of online purchasing interests of USER-1 appears after USER-1 enters the words “Nikon Camera”. In window 250, there is a list of items, such as Nikon camera 251 and skies 252, that USER-1 is interested in purchasing online, as shown in FIG. 2C.

In addition to the online purchase interests box 210, there could be a list of purchasing categories 210 for USER-1 to choose. For example, categories 210 can include: cars 211, camera 212, toy 213, etc. USER-1 can click on one of the categories to drill into more subcategories. For example, USER-1 clicks on the category “camera” 212. A window 270 appears. Window 270 includes different types of cameras offered by different merchants. For example, window 270 includes cameras offered by Nikon, Canon and other merchants. Under the category of Nikon camera, there is a list of models, such as model-1 271, model-2 272, model-3 273, and model-4 274, as shown in FIG. 2D. USER-1 can click on each model to learn more about the model. For example, when USER-1 clicks on model-1 271, a window 275 appears. In window 275, there is a product description space 278 that describes model-1 of Nikon camera, as shown in FIG. 2E. If USER-1 is interested in purchasing such a model, USER-1 can push “interested in purchasing” button 276. If not, USER-1 can push the close button 277.

When USER-1 pushes button 276 to indicated that he/she is interested in purchasing model-1 of Nikon cameras, USER-1's purchasing interest is recorded in the online-purchase-interests server 126 following path 280, as shown in FIG. 2F. After USER-1 pushes button 276 to indicated that he/she is interested in purchasing Nikon model-1 camera, window 250′ that shows a revised summary of USER-1's online purchasing interests appears, as shown in FIG. 2G. USER-1's interest in purchasing model-1 of Nikon is recorded in field 251′ of USER-1's interest in camera,

In front of each category, such as car 211, camera 212, and toy 213, in FIG. 2B, there is a selection box 221, 222, or 223 for USER-1 to make selection. USER-1 can select categories at different depth (or specificity). In window 200, there is a “close” button 230, which closes widow 200 when pushed.

Based on USER-1's online purchase interest profile stored in server 126, which is coupled to ad server 125, ad server 125 matches available advertisements based on USER-1's profiles. In addition to taking information of online purchasing interest profiles of users stored in User Online Purchasing Interest server 126, ad server 125 can also takes other types of user profiles stored in other user profile servers, such as general-user-profile server 127. Information stored in general-user-profile server 127 can be gathered by users' past online searching, ad viewing, purchasing, or other online activities. However, the Internet portal does not share advertisement revenue with users when they make transactions following the ads generated based on general user profiles.

When ad server 125 decides what ads to show to USER-1, ads matches USER-1 online purchase interests stored in the online-purchase-interests sever 126 has higher priority than ads matches to USER-1's profile stored in General-user-profile sever 127, in accordance with one embodiment of the present invention. This is because USER-1 is interested in purchasing products or services in the ads matching USER-1's online purchase interests. In contrast, the ads that match USER-1's profile are “guessed” by the Internet portal to be of interest to USER-1. They are not requested by USER-1. In addition, ads related to USER-1 online purchase interests that are based on CPA model, which the Internet portal is interested in offering a discount/reward should have the highest priority of being displayed to USER-1, because they are requested directly by USER-1. USER-1 reveals his/her online purchasing interests with the knowledge that he/she could get rewards if he/she makes purchases following matched ads. If this type of ads, ads based on CPA model and fits USER-1's online purchasing interest profiles, are not available, ads that only matches USER-1's online purchasing interests revealed by USER-1 or ads that fit the more general user profile can be displayed.

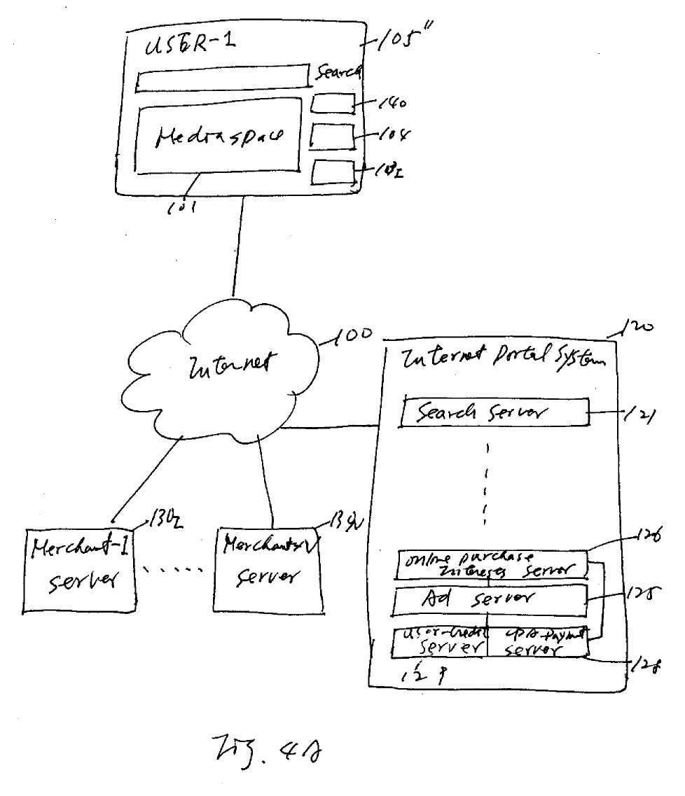

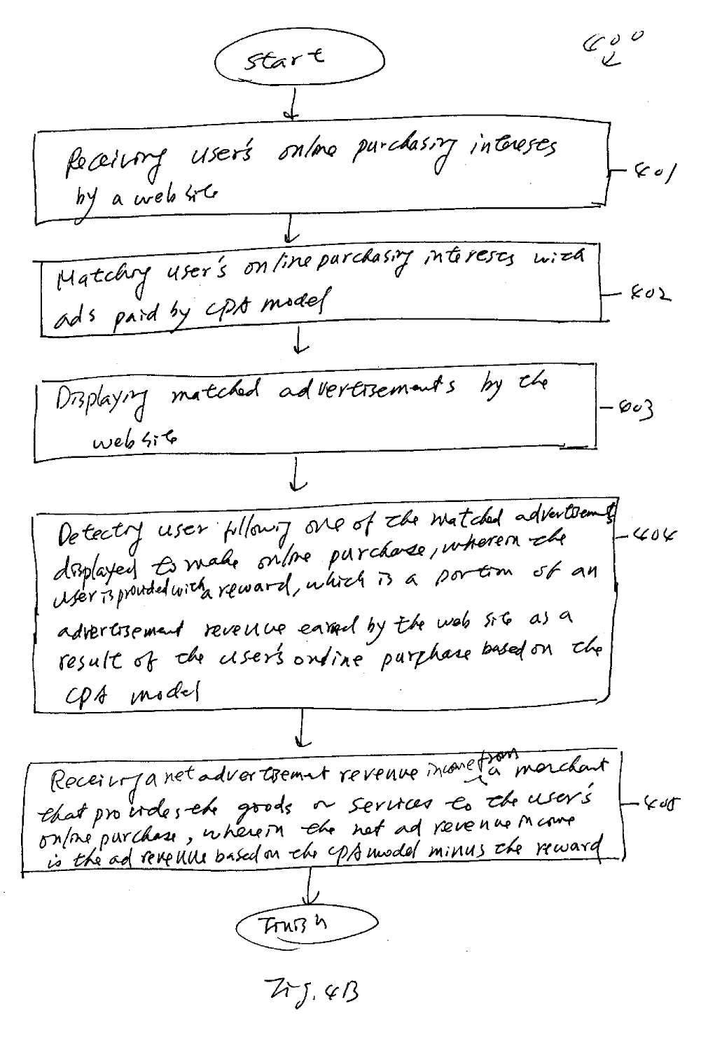

FIG. 3A shows a window 105″ of USER-1, when USER-1 is interacting with the Internet portal system 120, in accordance with one embodiment of the present invention. In window 105″ of USER-1 there are two ads available. The first ad is Ad-R1 104, which is marked with a symbol, such as a star 301, that indicates there is a discount/reward available with the ad, in accordance with one embodiment of the present invention. The second ad in window 105″, Ad-1 103_{I}, is not marked with the symbol of discount/reward. Ad-1 103_{I} is selected by the ad-server based on USER-1's online purchasing interest profile or general profile of USER-1, however, the ad is not paid based on CPA model; therefore, Internet portal system 120 does not mark it with discount/reward. The Internet portal does not intend to share ad revenue with USER-1 based on this ad.

When USER-1 clicks on Ad-R1 104, a window 300 (as shown in FIG. 3B) shows an ad that is paid by CPA model by the advertiser, or merchant who sponsors the ad, and matches USER-1 online purchasing interests, entered by USER-1, in accordance with one embodiment of the present invention. Ad-R1 104 shown in window 300 includes a word space 310 that describes includes a discount/reward. For example, the word space 310, which contains description such as “Deal matches your online purchasing interest!”, which indicates that there is a deal (or discount) associated with the ad. Below the word space 310, there is a product/service description space 320, which displays the traditional ad for the product, for example an ad for Nikon model-1 camera. In one embodiment, the displayed ad includes the price for the product or services. Below the ad of the product, there is a description space 340, which contains descriptions, such as “Purchase Now to Receive Reward Offered by Yahoo!'s Tell-Us-Shop-With-Reward”, assuming Yahoo! being the Internet portal. This description, in description space 340, indicates to users that the discount is offered by Yahoo! and the discount is a result of USER-1 telling Yahoo! which products USER-1 is interested in purchasing. The description also tells USER-1 that USER-1 can only get the discount if USER-1 makes the purchase following the ad.

Below the description space 340, there are two reward selections that USER-1 can take, in accordance with one embodiment of the present invention. For example, one is a 5% discount directly from taken during online purchasing. This discount can be taken off during USER-1's purchasing with the merchant that sells the product or service, such as Nikon. Internet portal will just get paid less (less the amount of reward) for the ad by CPA model from the advertiser (or merchant). If USER-1 wants to take a 5% discount at the time of purchase, USER-1 can push button 341 for “5% discount with merchant”. Alternatively, if USER-1 wants to take a 5% discount in the form of Yahoo! credit, USER-1 can push the button 342 of “5% discount with Yahoo! credit.” USER-1 can accumulate Yahoo! credit to receive a check from Yahoo! or use the credit to purchase other items online.

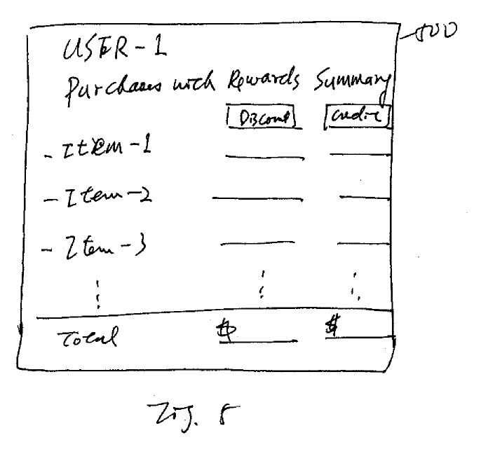

In order for the methodology and system to work, the company owning the Internet portal should have legal contracts and systems in place that enable CPA payment model for advertisements. FIG. 4A shows a CPA payment for ad system 400, in accordance with one embodiment of the present invention. As described above in FIGS. 1 and 2F, an Ad server 125 is in an Internet portal system 120. A number of servers of online merchants, such as Merchant-1 server 130, to Merchant-N server 130_{N} are coupled to Ad server 120 to provide ads to Ad server 125. As discussed above in FIG. 2F, Ad server 125 is coupled to or includes an online-purchase-interests sever 126, which stores users online purchasing interest profiles. Ad server 125 uses information on the online-purchase-interests server 126 to match ads paid by CPA model in order to display the matched ads to users, such as USER-1. The matched ad displayed to USER-1 includes a discount or reward offered by the Intranet portal, such as Yahoo!. After viewing ads, USER-1 makes one or more transactions following the matched ads.

Ad server 125 is also coupled to or includes a CPA payment server 128, which is also coupled directly or indirectly to the merchant servers, 130 to 130_{N}. In one embodiment, the merchant servers, 130_{I} to 130_{N}, provide sales information related to the matched ads, such as which user buy what item and if the user takes a discount with the merchant, etc. Alternatively, the purchase or transaction) activity of USER-1 can be tracked by a cookie associated with USER-1's interaction with the Internet portal. For example, Merchant-1, which is Nikon, relays information of USER-1 bought a model-1 camera that cost $400 and USER-1 took a 5% (or $20) discount with Merchant-1. Merchant-1 is supposed pay Internet portal $40 (or 10%) based on the CPA model. With the $20 paid to USER-1, Merchant-1 needs to pay the remaining $20 to Internet portal due to the purchasing activity of USER-1. The CPA payment server 128 records that Merchant-1 owes the Internet portal $20 based on USER-1's transaction.

As described above some users might take credit, such as Yahoo! credit, instead of discounts from the merchants. The decision to take credit can be due to personal preference or due to the fact that some users want to accumulate credits to purchase other items online. The decision to take credit is more likely when the discount is relatively small, such as a few cents to a few dollars, for relatively inexpensive items. Users might want to accumulate small credits into a larger sum to make online purchases. Alternatively, users can request the Internet portal, such as Yahoo!, to send checks with the amounts of credits accumulated. In one embodiment, the data of amount of credit accumulated by each user can be stored in a separate user-credit server 129, which is coupled to the CPA payment server. In one embodiment, the user-credit server 129 can also be coupled to the online-purchasing-interest server 126. Alternatively, all user online profile accumulated by the Internet portal system 120, such as by servers 126, 127, 128, and 129, are place in one single server.

FIG. 4B shows a process flow 400 of users using the systems shown in FIG. 2F and 4A to make online purchases to get a discount/reward from the Internet portal, in accordance with one embodiment of the present invention. At step 401, a user's online purchasing interests is received by an Internet portal or a web site that collects such information. At step 402, the user's online purchasing interests are matched with available advertisements paid by the CPA model by the Internet portal or web site. At step 403, matched advertisement(s) are displayed to the user. In one embodiment, the amount the discount or reward that the user could get from making purchase (or transaction) online following the advertisement is disclosed to the user in the displayed ad. At step 404, user's following the ad to make online transaction (or purchase) is provided with a reward offered by the Internet portal or web site is detected. The reward comes from the ad revenue generated by the displayed ad that the user makes a transaction. The ad revenue is paid by the merchant for the displayed ad, based on CPA model. At step 405, a net ad revenue for the user's purchasers) based on the CPA model from the merchant (or advertiser) involved in the online purchase is received. The net ad revenue income the Internet portal or web site receives is reduced by the discount offered by the Internet portal or web site to the user. If the user decides to take rewards, such as credits or checks, from the Internet portal or web site, the total amount of ad revenue related to the purchase by the user is received from the advertiser or the merchant.

In one embodiment, in window 200 of FIG. 2B, there is a button 220 of purchases with rewards history for USER-1. When USER-1 pushes button 220, a window 500 showing a summary of purchases with rewards history for USER-1 appears. In this summary, as shown in FIG. 5, how many items USER-1 has shopped with such a method is listed. The summary can also include how much discounts or rewards USER-1 has accumulated.

The methods and systems discussed above are centered on users entering purchasing interests with an Internet portal. This is because the Internet portal has a large amount of users, such as 100 millions or more users, using the different components (or services) available at the Internet portal. Due to the large amount of users, the CPA model can work well. To increase the amount of online purchase transaction based on ads to increase ad revenue collected through CPA model and to improve user satisfaction and trust, Internet portals are interested in offering ads that match users' purchasing needs. Although the discussion is centered around Internet portal, the concept can be applied to other web sites that offer services, such as communication, exchanges, community building, or community forming, and search. Web sites that offer such services tend to have a large number of users. Merchants like to put out ads on these types of web sites to promote sales of their products and services. However, the methods and systems based on the concept of the current invention can be applied to any other web sites or services that have CPA payment model established.

The methods and systems of the current invention improves user satisfaction in receiving relevant ads and users' trust in web sites or Internet portal for not establishing the users' profiles by reviewing users' personal data, such as emails and messages. The methods and systems of the current invention also appeal to the advertisers and/or merchants because advertisers and/or merchants only have to pay for ads that really convert into real transactions. CPA model is very beneficial to the advertisers and/or merchants. The Internet portals or web sites also stand to gain from successful implementation of such methods and systems. High ad revenue can be gained due to more users using such methods and systems to make online purchases. In addition, The Internet portals and web sites can gain more loyal users due to higher user satisfaction and trust.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for incentivizing a user to reveal the user's online purchasing interests, comprising:
receiving the user's online purchasing interests in a web site coupled to the Internet;
matching the user's online purchasing interests with advertisements paid by a click-per-action (CPA) model;
displaying advertisements matched with the user's online purchasing interests to the user by the web site; and
detecting the user following one of the matched advertisements to make an online purchase, wherein the user is provided with a reward by the web site, the reward being a portion of an advertisement revenue earned by the web site as a result of the user's online purchase based on the CPA model.

2. The method of claim 1, further comprising:
receiving a net advertisement revenue income from a merchant involved with the online purchase, wherein the net advertisement revenue is the advertisement revenue based on the CPA model reduced by the reward received by the user.

3. The method of claim 1, wherein the reward is a discount with the merchant or a credit with the web site.

4. The method of claim 1, wherein the web site and the merchant have contracts and systems in place for handling advertisement revenue based on CPA model.

5. The method of claim 1, the web site provides the portion of advertisement revenue paid by CPA model to incentivize the user to reveal the user's online purchasing interests to the web site.

6. The method of claim 1, wherein the web site is an Internet portal, an online-group site, a social-networking site, an information-providing site, a search site, or an instant messaging site.

7. The method of claim 1, wherein the method increases user's satisfaction due to the displayed advertisements matching the user's purchasing interests and also due to the user's receiving the reward.

8. The method of claim 1, wherein method is used to increases overall advertisement revenue for the web site due to more users utilizing the method for online purchasing.

9. The method of claim 1, wherein the portion of advertisement revenue is set to be sufficient to incentivize the user to reveal the user's online purchasing interests to the web site.

10. A system for managing user interaction with advertisements, comprising:
a web site for displaying advertisements and content;
an online-purchasing-interests server for storing a user's online purchasing interests; and
an advertisement server for storing advertisements paid by a click-per-action (CPA) model, the advertisement server configured to match the user's online purchasing interests with the stored advertisements, the advertisement server configured to display matched advertisements on the website for a user, the advertisement server including logic for detecting when the user follows one of the displayed matched advertisements and makes an online purchase and provides a reward to the user, the reward being a portion of an advertisement revenue earned by the web site that is directly related to the online purchase.

11. A system of claim 10, wherein the reward acts to provide an incentive to the user to reveal the user's online purchasing interests.

12. The system of claim 10, further comprising:
a web server configured for preparing a web page to collect the user's online purchasing interests, which are stored in the online-purchasing-interests server, wherein the web server is coupled to the online-purchasing-interests server.

13. The system of claim 10, wherein the web server prepares a web page to display the matched advertisements in the web site.

14. The system of claim 10, further comprising:
an advertisement-revenue server configured for managing collecting the advertisement revenue based on the CPA model from a merchant that the user makes the online purchase with, wherein the advertisement revenue collected is reduced by the portion of advertisement revenue provided to the user as the reward.

15. The system of claim 14, further comprising:
a merchant server, wherein the merchant server is configured to manage the payment of the advertisement revenue and is coupled to the advertisement-revenue server.

16. The system of claim 15, wherein the merchant server is configured to provide the reward to the user as a discount.

17. The system of claim 10, further comprising:
a user-credit server, wherein the user-credit server is configured to provide the reward to the user as a credit and is coupled to the advertisement server and the advertisement-revenue server.

18. Computer readable media including program instructions for incentivizing a user to reveal the user's online purchasing interests, comprising:
program instructions for receiving the user's online purchasing interests in a web site coupled to the Internet;
program instructions for matching the user's online purchasing interests with advertisements paid by a click-per-action (CPA) model;
program instructions for displaying advertisements matched with the user's online purchasing interests to the user by the web site; and
program instructions for detecting the user following one of the matched advertisements to make an online purchase, wherein the user is provided with receives a reward, the reward being the portion of the advertisement revenue earned by the web site as a result of the user's online purchase based on the CPA model.

19. The computer readable media of claim 18, further comprising:
program instructions for receiving the advertisement revenue from a merchant, that the user makes the online purchase with, wherein the web site eventually receives a net advertisement revenue, which is the advertisement revenue reduced by the reward received by the user.

20. The computer readable media of claim 18, wherein the web site is an Internet portal, an online-group site, a social-networking site, an information-providing site, a search site, or an instant messaging site.

21. The computer readable media of claim 18, wherein the portion of advertisement revenue provided to the user is set to be sufficient to incentivize the user to reveal the user's online purchasing interests to the web site.
